(19) United States
(12) Patent Application Publication
(10) Pub. No.: US 2012/0015202 A1
(43) Pub. Date: Jan. 19, 2012

(54) Thermoplastic Elastomer Compositions, Articles Made Therefrom, and Methods for Making Such Articles

(76) Inventors: Leander Kenens, Kessel-Lo (BE); Eric P. Jourdain, Rhode Saint Genese (BE); Norman G. Barber, Norwalk, OH (US); Tonson Abraham, Strongsville, OH (US); Felix M. Zacarias, Akron, OH (US); Anthony Poloso, Houston, TX (US)

(21) Appl. No.: 13/171,104

(22) Filed: Jun. 28, 2011

Related U.S. Application Data
(60) Provisional application No. 61/365,222, filed on Jul. 16, 2010.

(51) Int. Cl. B32B 27/08; C08L 77/00; B32B 27/00; C08L 83/04

(52) U.S. Cl. 428/516; 525/101; 525/179; 525/92 B; 428/500

(57) ABSTRACT

Provided are TPV formulations having beneficial properties, such as scratch resistance, improved bondability, e.g., nylon bondability, and improved processability. Preferred TPVs provide lower density, lower cost, and good extrusion capabilities compared to conventional formulations. Sealing systems may be prepared with the TPVs described above. An exemplary automotive sealing system includes a sealant foot and a sealant lip.

### CROSS REFERENCE TO RELATED APPLICATIONS

This application claims priority to and the benefit of Provisional Application No. 61/365,222, filed on Jul. 16, 2010, the disclosure of which is incorporated by reference in its entirety.

### FIELD OF THE INVENTION

This invention relates to thermoplastic elastomer compositions, articles made therefrom, and methods of for making such articles. More particularly, the invention relates to thermoplastic vulcanizate compositions used in automotive sealing systems, such as glass run channel, glass encapsulation, and belt line seals.

### BACKGROUND OF THE INVENTION

Thermoplastic elastomers have many properties of thermoset elastomers, yet are processable as thermoplastics. One type of thermoplastic elastomer is a thermoplastic vulcanizate, which is characterized as a fine rubber particles dispersed within a plastic phase. The rubber particles may be crosslinked to promote elasticity. Thermoplastic vulcanizates are conventionally produced by dynamic vulcanization, which is a process whereby a rubber is cured or vulcanized within a blend with at least one non-vulcanizing polymer while the polymers are undergoing mixing or masticating, preferably above the melt temperature of the non-vulcanizing polymer.

The presence of the rubber, however, makes these thermoplastic vulcanizates difficult to process after dynamic vulcanization. As a result, heavier demands are placed upon processing machinery, especially as the amount of rubber within the thermoplastic vulcanizate is increased.

Conventionally, these processing problems have been alleviated by reducing the amount of cure, by using lower molecular weight thermoplastic resins, or by using processing oils such as paraffinic oils and waxes, processing aids such as metal stearates or fatty acid amides, or surfactants such as sulfate and sulfonate salts.

Because conventional approaches to alleviating processing difficulties can deleteriously impact the mechanical properties of thermoplastic elastomers, there is a need for thermoplastic elastomers that have improved processability without inferior mechanical properties.

### SUMMARY OF THE INVENTION

Provided are TPV formulations having beneficial properties, such as scratch resistance, improved bondability, e.g., nylon bondability, and improved processability. Preferred TPVs provide lower density, lower cost, and good extrusion capabilities compared to conventional formulations.

Scratch resistance TPVs are useful for automotive applications that have a surface that must resist marking and scratching during handling, mounting on car and service, such as, sealing systems like glass run channel, glass encapsulation, belt line seals. The TPVs provided are less sensitive to scratch and therefore can be used for visible parts like automotive weatherseals.

An exemplary scratch-resistant TPV includes: (a) a thermoplastic phase comprising a propylene-based elastomer having a heat of fusion of less than 75 J/g and a Tₘ of less than 105° C.; (b) from about 0.1 to about 10.0 wt % of a siloxane masterbatch; and (c) a rubber phase. The siloxane masterbatch comprises siloxane and a carrier resin comprising polyethylene, polypropylene, poly alpha olefin copolymers, or combinations thereof. This embodiment improves scratch resistance for softer TPV, e.g., 60-70 Shore A Hardness, which may be sensitive to scratches due to weaker mechanical resistance to an indenter action.

Another exemplary nylon-bondable TPV includes: (a) a rubber phase, and (b) a thermoplastic phase comprising: (i) greater than 80 wt % of a functionalized polyolefin selected from the group consisting of polypropylene, polyethylene, poly alpha olefin copolymers, and blends thereof; (ii) a poly alpha olefin polymer comprising monomers derived from butene; and (iii) a polyamide.

Sealing systems may be prepared from the TPVs described above. An exemplary automotive sealing system includes a sealant foot and a sealant lip. The sealant lip includes: (a) a first olefinic thermoplastic component composed of a propylene copolymer having: (i) 60 wt % or more units derived from propylene; (ii) isotactically arranged propylene derived sequences; and (iii) a heat of fusion less than 45 J/g; (b) a second olefinic thermoplastic component; and (c) carbon black. The sealant lip is composed of an elastomeric component that includes an at least partially crosslinked rubber, and a thermoplastic component.

### BRIEF DESCRIPTION OF THE DRAWING

FIG. 1 illustrates mean failure height results from a Brewston Stair-Step drop test.

### DETAILED DESCRIPTION

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers. For example, the term “copolymer” includes the copolymerization reaction product of ethylene and an alpha-olefin, such as 1-hexene. However, the term “copolymer” is also inclusive of, for example, the copolymerization of a mixture of ethylene, propylene, 1-hexene, and 1-octene.

As used herein, when a polymer is referred to as “comprising a monomer,” the monomer is present in the polymer in the polymerized form of the monomer or in the derivative form the monomer.

As used herein, “molecular weight” means weight average molecular weight (“Mw”). Mw is determined using Gel Permeation Chromatography. Molecular Weight Distribution (“MWD”) means Mw divided by number average molecular weight (“Mn”). (For more information, see U.S. Pat. No. 4,540,753 to Cozewith et al. and references cited therein, and in Ver Strate et al., 21 MACROMOLECULES, pp. 3360-3371 (1998)). The “Mz” value is the high average molecular weight value, calculated as discussed by A. R. Cooper in Concise Encyclopedia of Polymer Science and Engineering, pp. 638-639 (J. I. Kroschwitz, ed. John Wiley & Sons 1990).

As used herein, the term “thermoplastic vulcanizate composition”, “thermoplastic vulcanizate”, or “TPV” means a blend of a rubber component that is at least partially vulcanized, and a thermoplastic component. Usually, the rubber component is dispersed within the thermoplastic component, i.e., the rubber component is a dispersed phase. However, in some embodiments, a “phase” inversion occurs in which the thermoplastic component is dispersed within the rubber component. TPVs optionally contain many additional additives such as oils, colorants, fillers, etc.

As used herein, the term “vulcanizate” means a composition that includes a component, e.g., rubber component, that has been vulcanized as commonly used by those skilled in the art, i.e., at least a portion of the composition has been subjected to some degree of vulcanization. Accordingly, “vulcanizate” encompasses both partial and total vulcanization. A preferred type of vulcanization is “dynamic vulcanization,” which also produces a “vulcanizate.” In one or more embodiments, the “vulcanized” refers to curing, or crosslinking, that results in a measurable change in pertinent properties, e.g., a change in the melt index (“MI”) of the composition by 10% or more (according to ASTM D1238 under any of its stated conditions). “Vulcanization” encompasses any form of curing, or crosslinking, including both thermal and chemical processes.

As used herein, “dynamic vulcanization” means a vulcanization process in which a vulcanizable elastomer is vulcanized under conditions of high shear in the presence of a thermoplastic polyolefin resin. As a result, the vulcanizable elastomer is simultaneously crosslinked and dispersed as fine particles of a “micro gel” within the resin.

A “fully vulcanized” (or fully cured or fully crosslinked) rubber in which a given percentage range of the crosslinkable rubber is extractable in boiling xylene or cyclohexane, e.g., 5 wt % or less, or 4 wt % or less, or 3 wt % or less, or 2 wt % or less, or 1 wt % or less. The percentage of extractable rubber can be determined by the technique set forth in U.S. Pat. No. 4,311,628, and the portions of that patent referring to that technique are hereby incorporated by reference for all jurisdictions where such incorporation is permitted.

As used herein, “adhere(d),” in particular when used to describe the interaction or connection of one component or structure with another, means any method of joining known to those of skill in the joining arts whether by mechanical (including electromechanical), chemical and/or physical means. For example, mechanical means includes, but is not limited to application of an external force, clamping or securing with nuts and bolts. Chemical means include, but are not limited to, bond interaction between atoms or parts of atoms such as hydrogen, polar, ionic or covalent bonds. Physical means include, but are not limited to, high surface area interactions, chain entanglements, co-crystallization and Van der Waals' forces. A particular type or class of adherence may be described by applying the general category of the adherence as an adjective modifier, for example “chemically adhered” refers to those chemical means of adhering described above. “At least partially adhered” means some level of adherence greater than zero, for instance, it includes partial lamination, but would not include complete de-lamination of two components of the composite structures.

As used herein, “weight percent” or “wt %”, unless noted otherwise, means a percent by weight of a particular component based on the total weight of the composition containing the component. For example, if a mixture contains three pounds of sand and one pound of sugar, then the sand comprises 75 wt % (3 lbs. sand/4 lbs. total mixture) of the mixture and the sugar 25 wt %.

As used herein, “phr” is a measurement of the number of parts by weight of a non-rubber component of a thermoplastic elastomer or thermoplastic vulcanizate per 100 parts by weight of the rubber component of the thermoplastic elastomer or thermoplastic vulcanizate. For example, if a thermoplastic vulcanizate contains 15 parts by weight thermoplastic, 2.5 parts by weight carbon black and 250 parts by weight rubber, then it can be said to contain 6 phr thermoplastic and 1 phr carbon black. The term “phr” is commonly used by those of skill in the art of thermoplastic elastomers and vulcanizates and is readily understood by them to be as defined herein.

As used herein, Melt Flow Rates (“MFR”) are determined in accordance with ASTM D1238 at 230° C. and 2.16 kg weight.

As used herein, Melt Indices (“MI”) are determined in accordance with ASTM D1238 at 190° C. and 2.16 kg weight.

### Rubber Components

The “rubber component” or “rubber” are conventional rubber materials that are known to those skilled in the art, including both crosslinkable rubber, e.g., prior to vulcanization, or crosslinked rubber, e.g., after vulcanization. Rubber includes natural rubber, any olefin-containing rubber, such as ethylene-propylene copolymers (“EPM”), ethylene-propylene-diene (“EPDM”) rubber, EPDM-type rubber, or butyl rubber. The rubber may comprise a single rubber or a blend of rubbers.

An EPDM-type rubber are terpolymers derived from the polymerization of at least two different c₂-C₁₀ monoolefin monomers, preferably C₂-C₄ monoolefin monomers, and at least one C₅-C₂₀ poly-unsaturated olefin. Preferably, the monoolefins have the formula CH₂═CH—R where R is H or a C₁-C₁₂ alkyl. Preferably, the monoolefins are ethylene and propylene. The polyunsaturated olefin can be a straight chained, branched, cyclic, bridged ring, bicyclic, fused ring bicyclic compound, etc., and preferably is a nonconjugated diene.

Suitable dienes useful as comonomers are, for example, 1,4-hexadiene, 1,6-octadiene, 5-methyl-1,4-hexadiene, 3,7-dimethyl-1,6-octadiene, dicyclopentadiene (DCPD), ethylidiene norbornene (ENB), norbornadiene, 5-vinyl-2-norbornene (VNB), and combinations thereof. The diene, if present, is preferably VNB; thus norbornadiene, 5-vinyl-2-norbornene (EP(VNB)DM). An exemplary EPDM rubber is VX1696 offered by ExxonMobil Chemical Co.

“Butyl rubber” means any butyl rubber known to those skilled in the art, and includes a polymer that predominantly includes repeat units from isobutylene but also includes a few repeat units of a monomer that provides a site for crosslinking Monomers providing sites for crosslinking include a polyunsaturated monomer such as a conjugated diene or divinyl benzene. The polymer may be halogenated to further enhance reactivity in crosslinking. Preferably the halogen is present in amounts from about 0.1 to about 10 wt %, more preferably about 0.5 to about 3.0 wt % based upon the weight of the halogenated polymer; preferably the halogen is chlorine or bromine. Butyl rubber is commercially available from Exxon Chemical Co.

EPDM, butyl and halobutyl rubbers are rubbers low in residual unsaturation and are preferred when the vulcanizate needs good thermal stability or oxidative stability. The rubbers low in residual unsaturation desirably have less than or equal to 10 wt % repeat units having unsaturation. Desirably excluded are acrylate rubber and epichlorohydrin rubber.

Other non-limiting examples of rubbers are halobutyl rubbers and halogenated (e.g., brominated) rubber copolymers of p-alkylstyrene and an isomonoolefin having from 4 to 7 carbon atoms (e.g., isobutylene). Still other examples are rubber homopolymers of conjugated dienes having from 4 to 8 carbon atoms and rubber copolymers having at least 50 wt % repeat units from at least one conjugated diene having from 4 to 8 carbon atoms.

Rubbers can also be natural rubbers or synthetic homo or copolymers of at least one conjugated diene. Those rubbers are higher in unsaturation than EPDM rubber or butyl rubber. Those rubbers can optionally be partially hydrogenated to increase thermal and oxidative stability. Desirably those rubbers have at least 50 wt % repeat units from at least one conjugated diene monomer having from 4 to 8 carbon atoms. Comonomers that may be used include vinyl aromatic monomer(s) having from 8 to 12 carbon atoms and acrylonitrile or alkyl-substituted acrylonitrile monomer(s) having from 3 to 8 carbon atoms. Other comonomers desirably include repeat units from monomers having unsaturated carboxylic acids, unsaturated dicarboxylic acids, unsaturated anhydrides of dicarboxylic acids, and include divinylbenzene, alkylacrylates and other monomers having from 3 to 20 carbon atoms.

Rubbers can also be synthetic rubber, which can be nonpolar or polar depending on the comonomers. Examples of synthetic rubbers include synthetic polyisoprene, polybutadiene rubber, styrene-butadiene rubber, butadiene-acrylonitrile rubber, etc. Amine-functionalized, carboxy-functionalized or epoxy-functionalized synthetic rubbers may be used, and examples of these include maleated EPDM, and epoxy-functionalized natural rubbers. These materials are commercially available. Non-polar rubbers are preferred; polar rubbers may be used but may require the use of one or more compatibilizers, as is well known to those skilled in the art.

Conjugated diene rubber may include styrene/butadiene rubber, polybutadiene rubber, polyisoprene rubber, and blends thereof, with styrene/butadiene rubber being preferred. Unsaturated styrenic triblock copolymer rubber may include styrene/isoprene/styrene “SIS” and styrene/butadiene/styrene “SBS” rubber. Hydrogenated styrenic triblock copolymer rubber include SEBS (styrene/ethylene-butylene/styrene), SEPS (styrene/ethylene-propylene/styrene), SEEPS (styrene/ethylene-ethylene-propylene/styrene), and blends thereof, each of which is commercially available and are described in further detail in US 2004/0132907.

SB rubber refers to random block copolymers of styrene and butadiene. The SB rubber may have a styrene content of between 1 to 50 wt % of the SB rubber. Styrene content of between 15% and 45%, and preferably between 20% and 40%, and still more preferably between 20% and 30% are also contemplated in accordance with the present invention. Suitable butadiene micro structures may include 1,2-butadiene, and cis and trans 1,4-butadiene. The copolymer may be prepared in any of the well known conventional processes, such as through solution or emulsion polymerization. The weight percent of the butadiene in the SB rubber may range from 50 to 99 wt %. Weight percents of butadiene in the SB rubber of between 85% and 55%, and preferably between 80% and 60%, and still more preferably between 80% and 70% are contemplated in accordance with the present invention. Larger or smaller amounts of butadiene may be employed. The butadiene portion may contain from 10% to 90% of 1,2-polybutadiene, with the remainder consisting essentially of cis and trans 1,4-polybutadiene. The ratio of cis to trans isomers in the 1,4-polybutadiene may be between 0.2 and 0.65. The molecular weight, on a number average value, may be from 30,000 to greater than one million.

A list of preferred rubber components includes any rubber selected from the following: ethylene-propylene rubber (EPM), ethylene-propylene-diene rubber (EPDM), natural rubber (polyisoprene), butyl rubber, halobutyl rubber, halogenated rubber copolymer of p-alkystyrene and at least one C₄-C₇ isomonoolefin, a copolymer of isobutylene and divinyl-benzene, homopolymers of a conjugated diene (preferably a C₄-C₈ conjugated diene), copolymers of at least one conjugated diene and a comonomer (preferably where the copolymer has at least 50 wt % repeat units from at least one C₄-C₈ conjugated diene and/or the comonomer is a polar monomer, a C₈-C₁₂ vinyl aromatic monomer, an acrylonitrile monomer, a C₃-C₈ alkyl substituted acrylonitrile monomer, an unsaturated carboxylic acid monomer, an unsaturated anhydride of a dicarboxylic acid or a combination thereof), unsaturated non-polar elastomers, polybutadiene elastomer, styrene-butadiene elastomer and mixtures thereof.

### Thermoplastic Component

The “thermoplastic component” or “thermoplastic” includes any material known to those skilled in the art that is capable of softening or fusing when heated and of hardening again when cooled and that is not “rubber” as defined herein. The thermoplastic component includes: crystallizable polyolefins, polyimides, polyamides, polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, fluorine-containing thermoplastics, polyurethanes and mixtures thereof.

In one or more embodiments, the thermoplastic resin is preferably a polypropylene, such as isotactic polypropylene, having a melting point greater than 110° C., or 120° C., or 130° C., or 140° C., or 150° C. In certain embodiments, the thermoplastic resin may include a polypropylene polymer having a MFR of 1.0 to 30 dg/min. Alternatively, the thermoplastic component may include a “fractional” polypropylene having a melt flow rate less than 1.0 dg/min. In yet another embodiment, the thermoplastic resin further includes a first polypropylene having a melting point greater than 110° C. and a melt flow ranging from 1.0 to 30 dg/min and a second polypropylene having a melting point greater than 110° C. and a melt flow of less than 1.0 g/min.

Preferably, the polypropylene used in the first components described herein that has a melting point above 110° C. includes at least 90 wt % propylene units and is isotactic. Alternatively, instead of isotactic polypropylene, a first component of the present invention may include a syndiotactic polypropylene, which in certain cases can have a melting point above 110° C. Yet another alternative thermoplastic resin can include an atactic polypropylene. The polypropylene can either be derived exclusively from propylene monomers, i.e., having only propylene units, or be derived from mainly propylene, i.e., more than 80% propylene. As noted herein, certain polypropylenes having a high MFR, e.g., from a low of 10, or 15, or 20 dg/min to a high of 25 or 30 dg/min, may be used. Others having a lower MFR, e.g., “fractional” polypropylenes which have an MFR less than 1.0 dg/min may also be used.

A preferred thermoplastic resin is high-crystalline isotactic or syndiotactic polypropylene. This polypropylene generally has a density of from about 0.85 g/cm³ to about 0.91 g/cm³, with the largely isotactic polypropylene having a density of from 0.90 g/cm³ to 0.91 g/cm³.

The thermoplastic component may be present in the TPV in an amount of from any of the lower limits of 5, 8, 10, or 15 phr to any of the upper limits 20, 40, or 65 phr. The amount of the plastic phase of the TPV as a percentage by weight of the total amount of the elastomer plus the plastic phase may be from 20% to 80%, and another embodiment from 30 to 70 wt %, and in yet another embodiment from 40 to 60 wt %, and in still a more preferred embodiment from 35 to 55 wt %.

### Propylene Copolymer

In one or more embodiments, the thermoplastic component includes a “propylene copolymer.” A “propylene copolymer” includes at least two different types of monomer units, one of which is propylene. Suitable monomer units include, but are not limited to, ethylene and higher alpha-olefins ranging from C₄-C₂₀, such as, for example, 1-butene, 4-methyl-1-pentene, 1-hexene or 1-octene and 1-decene, or mixtures thereof, for example. Preferably, ethylene is copolymerized with propylene, so that the propylene copolymer includes propylene units (units on the polymer chain derived from propylene monomers) and ethylene units (units on the polymer chain derived from ethylene monomers).

In one or more embodiments, the propylene copolymer contains at least 75 wt % of propylene-derived units. In one or more embodiments, the propylene copolymer contains from 75 to 95 wt % of propylene-derived units. In one or more embodiments, the propylene copolymer contains from 80 to 90 wt % of propylene-derived units. In one or more embodiments, the propylene copolymer can consist essentially of from 80 to 95 wt % repeat units from propylene and from 5 to 20 wt % of repeat units from one or more unsaturated olefin monomers having 2 or 4 to 12 carbon atoms.

Preferably, the propylene copolymer has crystalline regions interrupted by non-crystalline regions. The non-crystalline regions may result from regions of non-crystallizable polypropylene segments, the inclusion of comonomer units, or both. In one or more embodiments, the propylene copolymer has a propylene-derived crystallinity that is isotactic, syndiotactic, or a combination thereof. In a preferred embodiment, the propylene copolymer has isotactic sequences. The presence of isotactic sequences can be determined by NMR measurements showing two or more propylene derived units arranged isotactically. Such isotactic sequences may, in some cases be interrupted by propylene units that are not isotactically arranged or by other monomers that otherwise disturb the crystallinity derived from the isotactic sequences.

In one or more embodiments, the propylene-derived units of the propylene copolymer have an isotactic triad fraction of about 65% to about 99%. In one or more embodiments, the propylene-derived units of the propylene copolymer have an isotactic triad fraction of about 70% to about 98%. In one or more embodiments, the propylene-derived units of the propylene copolymer have an isotactic triad fraction of about 75% to about 97%.

Due to the introduction of errors in the insertion of propylene and/or by the presence of comonomer, the crystallinity and the melting point of the propylene copolymer are reduced compared to highly isotactic polypropylene. For example, the propylene-derived crystallinity of the propylene copolymer may range from about 2% to about 65% in one embodiment and from about 5% to about 40% in another embodiment as measured by Differential Scanning calorimetry (DSC).

The crystallinity of the propylene copolymer can also be expressed in terms of “heat of fusion,” measured using a Differential Scanning calorimetry (DSC) test, most preferably in accordance with ASTM E-794-95. Preferably, about 6 mg to about 10 mg of a sheet of the polymer to be tested is pressed at approximately 200° C. to 230° C., then removed with a punch die and annealed at room temperature for 48 hours. At the end of that period, the sample is placed in a Differential Scanning calorimeter (Perkin Elmer 7 Series Thermal Analysis System) and cooled to about −50° C. to −70° C. The sample is heated at about 10° C./min to attain a final temperature of about 180° C. to about 200° C. The thermal output is recorded as the area under the melting peak(s) of the sample, which is typically at a maximum peak at about 30° C. to about 175° C. and occurs between the temperatures of about 0° C. and about 200° C. The thermal output is measured in Joules as a measure of the heat of fusion.

The propylene copolymer may have a heat of fusion ranging broadly from 1.0 J/g to 90 J/g; or more narrowly from 2 J/g to 40 J/g; or from 5 J/g to 35 J/g; or from 7 J/g to 25 J/g. In one or more specific embodiments, the propylene copolymer has a heat of fusion of 75 J/g or less, or 50 J/g or less, or 35 J/g or less. Preferably, the propylene copolymer has a heat of fusion less than 45 J/g.

The “melting point” can be measured using the DSC test described above. Using the DSC test, the melting point is the temperature recorded corresponding to the greatest heat absorption within the range of melting temperature of the sample. When a single melting peak is observed, that peak is deemed to be the “melting point.” When multiple peaks are observed (e.g., principal and secondary peaks), then the melting point is deemed to be the highest of those peaks. It is noted that at the low-crystallinity end at which elastomers are commonly found, the melting point peak may be at a low temperature and be relatively flat, making it difficult to determine the precise peak location. Furthermore, as with the DSC method, the peak location may be influenced by annealing and relaxation treatments. Therefore, it is recommended that the sample pretreatment procedure stated above for the DSC be followed.

The propylene copolymer may have any one of the following melting points, ranging from a lower limit of 25° C., or 30° C., or 35° C., or 40° C., or 45° C., or 50° C., to a higher limit of 105° C., or 100° C., or 95° C., or 90° C., or 85° C., or 80° C., or 85° C., or 80° C., or 75° C., or 70° C. In other specific embodiments, the melting point of the propylene copolymer can be expressed as any one of a selection of ranges, e.g., ranges of from 30° C. to 70° C. or from 40° C. to 50° C.

The crystallinity interruption described above may be predominantly controlled by the incorporation of the non-propylene monomer units. Accordingly, the comonomer content of the propylene copolymer may range from about 5 wt % to about 30 wt % in one embodiment and from about 8 wt % to about 30 wt % in another embodiment and from about 8 wt % to about 15 wt % in still another embodiment. In one or more of the compositions described herein, the propylene copolymer can have a comonomer content of greater than 8 wt %; or greater than 10 wt %; or greater than 12 wt %; or greater than 15 wt %.

Furthermore, the propylene-derived crystallinity of the propylene copolymer can be selected to ensure the desired compatibility with the other ingredients of the TPV composition, e.g., with the other polymers in the thermoplastic resin component, as well as with the rubber component and additives. In a preferred aspect, the propylene-derived crystallinity is selected relative to any polypropylene resin present in the thermoplastic resin component. In some embodiments, the tacticity of the propylene copolymer and the tacticity of the thermoplastic resin component (which may include two or more different polypropylene polymers) may be the same or substantially the same. By “substantially” it is meant that these two components have at least 80% of the same tacticity. In another embodiment, the components have at least 90% of the same tacticity. In still another embodiment, the components have at least 100% of the same tacticity. Even if the components are of mixed tacticity, e.g., being partially isotactic and partially syndiotactic, the percentages in each should be at least about 80% the same as the other component in at least one or more embodiments.

In one or more embodiments, the propylene copolymer is made using random polymerization methods, including those described in U.S. Pat. Nos. 6,288,171; 6,525,157; 5,001,205; International Application Nos. WO 96/33227; WO 97/22639; U.S. Pat. Nos. 4,543,399; 4,588,790; 5,028,670; 5,317,036; 5,352,749; 5,405,922; 5,436,304; 5,453,471; 5,462,999; 5,616,661; 5,627,242; 5,665,818; 5,668,228; 5,677,375; 5,693,727; 3,248,179; 4,613,484; 5,712,352; European Patent Application Nos. EP-A-0 794 200; EP-A-0 802 202; and EP-B-634 421. However, the propylene copolymer is not limited by any particular polymerization method. Suitable polymerization methods include gas phase, slurry, and solution, for example.

The propylene copolymer is also not limited by any or any particular type of reaction vessel. The propylene copolymer may in certain embodiments be formed in a single reactor. The propylene copolymer may in certain embodiments be formed in one or more series reactors (e.g., two or more reactors arranged in series). The propylene copolymer may in certain embodiments be formed in a batch reactor. Preferably, the continuous polymerization methods have sufficient back-mixing such that there are no concentration gradients within the reactor. Preferably, the propylene copolymer is formed using solution polymerization (as opposed to slurry or gas-phase polymerization) such that the catalyst system exists in a single-phase environment. Alternatively, however, in one or more specific embodiments, any propylene copolymer used in an elastomeric structure may be prepared using a single site catalyst capable of permitting tactic insertion. For example, in certain embodiments, a polymer made in accordance with the disclosure of International Application No. WO 03/0404201, is “propylene copolymer.”

In one or more embodiments, the propylene copolymer has a Shore A Hardness of less than about 90. In one or more embodiments, the propylene copolymer a Shore A Hardness of about 45 to about 90. In one or more embodiments, the propylene copolymer has a Shore A Hardness of about 55 to about 80.

In one or more embodiments, the propylene copolymer may have a molecular weight distribution (MWD) Mw/Mn ranging from 1.5 to 40; or from 2 to 20; or from 2 to 10; or from 2 to 5. In one or more embodiments, the propylene copolymer may have a number average molecular weight of from 10,000 to 5,000,000; or from 40,000 to 300,000; or from 80,000 to 200,000, as determined by gel permeation chromatography (GPC). In one or more embodiments, the propylene copolymer may have a weight average molecular weight (Mw) within the range having an upper limit of 5,000,000 g/mol, or 1,000,000 g/mol, or 500,000 g/mol, and a lower limit of 10,000 g/mol, or 15,000 g/mol, or 20,000 g/mol, or 80,000 g/mol. Further, the propylene copolymer may have a Mooney viscosity (ML (1+4)@125° C.) from a low of 50, or 60, or 75, to a high of 80, or 90, or 100.

Propylene copolymers are commercially available from ExxonMobil Chemical of Houston, Tex. as Vistamaxx propylene-based elastomers, including Vistamaxx propylene-based elastomer grades 2120, 2125, 2320, 2330, 3000, 3020, 3980, 6102, 6202, 3020(FL), 6102(FL), and 6202(FL). Propylene copolymers are also available from Dow Chemical Co. of Midland, Mich. as Versify elastomers.

### Additives

“Additive” includes additional components that may be added to the TPV. Additives include process oil, curing agent, fillers, carbon black, and other particulate fillers, silica, titanium dioxide, colored pigments, clay, zinc oxide, stearic acid, stabilizers, anti-degradants, flame retardants, processing aids, adhesives, tackifiers, plasticizers, wax, discontinuous fibers, such as cellulose fibers. Preferably, when non-black fillers are used, it is desirable to include a coupling agent to compatibilize the interface between the non-black fillers and the polymers. Desirable amounts of carbon black, when present, are from about 5 to about 250 phr.

Silicon containing additives are preferred in one or more embodiments. Preferred silicon containing additives are organosilicon additives. Preferred silicon additives are siloxanes having branched or unbranched backbones consisting of alternating silicon and oxygen atoms —Si—O—Si—O—. A preferred siloxane has the form R2SiO, where R is a hydrogen atom or a hydrocarbon group.

Polymerized siloxanes with organic side chains (R≠H) are commonly known as silicones or as polysiloxanes. Representative examples are [SiO(CH3)2]n (polydimethylsiloxane) and [SiO(C6H5)2]n (polydiphenylsiloxane). The organic side chains confer hydrophobic properties while the —Si—O—Si—O— backbone is purely inorganic.

Silicon containing additives are preferably employed as a masterbatch of silicon containing additive and a carrier resin, such as polyethylene, polypropylene, poly alpha olefin copolymer, or combinations thereof.

Preferred masterbatches are pelletized micro-dispersions of ultra high molecular weight siloxane polymers, in various different plastic carrier resins at loadings of up to 50%. Siloxane masterbatches are preferrably in solid form for ease of use. Such masterbatches typically contain 25-50% ultra high molecular weight siloxane polymers, e.g., >15 million cSt dispersed with an average particle size of 5 microns in various thermoplastics. Exemplary siloxane masterbatches are commercially available from Dow Corning.

In one or more embodiments, TPVs include from about 0.1 to about 10.0 wt % of a siloxane masterbatch. In some embodiments TPVs include from about 0.1 to about 1.0 wt % of a silicon containing additive, e.g., a siloxane masterbatch. In at least one embodiment, TPVs include from about 0.5 to about 5.0 wt %, or from about 0.5 to about 2.5, or from about 0.5 to about 1.5, or from about 3.4 to about 4.5 wt % of a silicon containing additive, e.g., siloxane masterbatch.

Addition of a silicon containing additive provides improved surface properties, including better lubricity, gloss and slip, and improved mar resistance and scratch resistance. The masterbatch can significantly reduce the coefficient of friction of a polymer.

### Curatives

Curatives vulcanize, i.e., crosslink, the rubber component. The curative used depends on the rubber component. Conventional curatives and curative systems include those known to those skilled in the art of TPVs. Curatives include, but are not limited to, phenolic resin curatives and sulfur curatives, with or without accelerators, accelerators alone, peroxide curatives, hydrosilation curatives using silicon hydride and platinum or peroxide catalyst, etc. Preferably, when the rubber component is an EPM, a peroxide curative is used.

Hydrosilylation has also been disclosed as a crosslinking method for thermoplastic vulcanizates and is suitable in the process of the invention. In this method a silicon hydride having at least two SiH groups in the molecule is reacted with the carbon-carbon multiple bonds of the unsaturated (i.e., containing at least one carbon-carbon double bond) rubber component of the thermoplastic elastomer, in the presence of the thermoplastic resin and a hydrosilylation catalyst. Silicon hydride compounds useful in the process of the invention include methylhydrogen polysiloxanes, methylhydrogen dimethyl-siloxane copolymers, alkyl methyl polysiloxanes, bis(dimethylsilyl)alkanes and bis(dimethylsilyl)benzene. See, U.S. Pat. Nos. 5,672,660, and 6,150,464, for further description, both are incorporated by reference.

The amount of curative used to prepare a first component TPV in the present invention may be readily determined by those of skill in the art based on (1) the type of curative, (2) the desired cure state of the rubber and (3) the amount and type of rubber present.

### Additive Oil

“Additive oil” means both “process oils” and “extender oils,” and each of those terms is defined herein in accordance with the broadest definition or usage of that term in any issued patent or publication. For example, extender oils include a variety of hydrocarbon oils and also include certain plasticizers, e.g., ester plasticizers. In an illustrative TPV, an additive oil can be present in amounts from about 5 to about 300 parts by weight per 100 parts by weight of the blend of rubber and thermoplastic components. The amount of additive oil may also be expressed as from about 30 to 250 phr, and more desirably from about 70 to 200 phr.

Many additive oils are derived from petroleum fractions, and have particular ASTM designations depending on whether they fall into the class of paraffinic, naphthenic, or aromatic oils. Other types of additive oils, which can be used in the TPVs herein, are alpha olefinic synthetic oils, such as liquid polybutylene, e.g., products sold under the trademark Parapol®. The type of additive oil utilized will be that customarily used in conjunction with a particular rubber component.

The quantity of additive oil can be based on the total rubber content, and defined as the ratio, by weight, of additive oil to total rubber in the TPV, and that amount may in certain cases be the combined amount of process oil, typically added during processing, and extender oil, typically added after processing. The ratio may range, for example, from about 0 to about 4.0/1. Other ranges, having any of the following lower and upper limits, may also be utilized in a TPV: a lower limit of 0.4/1, or 0.6/1, or 0.8/1, or 1.0/1, or 1.2/1, or 1.5/1, or 1.8/1, or 2.0/1, or 2.5/1; and an upper limit (which may be combined with any of the foregoing lower limits) of 4.0/1, or 3.8/1, or 3.5/1, or 3.2/1, or 3.0/1, or 2.8/1. Larger amounts of additive oil can be used, although the deficit is often reduced physical strength of the composition, or oil weeping, or both. Additive oils other than petroleum based oils can be used also, such as oils derived from coal tar and pine tar, as well as synthetic oils, e.g., polyolefin materials, e.g., Nexbase™, supplied by Fortum Oil N.V. Examples of plasticizers that are often used as additive oils are organic esters and synthetic plasticizers. Certain commercial rubber components, e.g., EPDM such as Vistalon 3666, include additive oil that is preblended before the rubber component is combined with the thermoplastic.

### Polyamides

Polyamides suitable for use in the present invention are high molecular weight polymers containing amide (—CONH₂) groups and are usually made by condensation of a carboxylic acid and a polyfunctional amine. Alternatively, the polyamide may be a urea-formaldehyde resin obtained by the condensation of formaldehyde and urea. The preferred polyamide is nylon, which is obtained by the condensation polymerization of the salt resulting from the reaction of adipic acid with hexamethylene diamine. The polymers obtained usually have molecular weights greater than 10,000 daltons, melting temperatures of about 263° C., specific gravities of about 1.14, tensile strengths of about 13,000 psi (89,632 kPa) and compressive strengths of about 11,000 psi (75,843 kPa). Preferred nylons include, but are not limited to, nylon 6, nylon 9, nylon 6,6, nylon 5,10, and nylon 6,12. Most preferred of these is nylon 6,6.

In principle, all types of polyamides are useful in certain aspects of the invention. The polyamides may include at least the aliphatic polyamides, for example, polyamide-4, polyamide-6, polyamide-8, polyamide-12, etc., polyamide-4,6, polyamide-6,6, polyamide-6,10, etc., all amorphous polyamides, which may be derived from an aliphatic diamine and an aromatic dicarboxylic acid, for example, polyamide-4,T, polyamide-6,T, polyamide-4,I, etc., in which T stands for terephthalate and I for isophthalate (further exemplified by Zytel 330 from E.I. DuPont De Nemours and Company, described by M. Xanthos, J. F. Parmer, M. L. LaForest, and G. R. Smith in Vol. 62, JOURNAL OF APPLIED POLYMER SCIENCES, p. 1167 (1996)), copolyamides of linear polyamides and copolyamides of an aliphatic and a partially aromatic polyamide, for example, 6/6,T, 6/6,6/6,T, etc. Polyamide-6 and polyamide-6.6 are preferred. The classes of polyamides described above are further detailed in Vol. 11, ENCYCLOPEDIA OF POLYMER SCIENCES AND ENGINEERING, pp. 315-381 (J. I. Kroschwitz, ed., John Wiley, New York, N.Y. (1988)), and NYLON PLASTICS HANDBOOK, pp. 377-387 (M. I. Kohan, Ed., Hauser\Gardner Publications, Inc., Cincinnati, Ohio (1995), which are both incorporated by reference. All-amorphous polyamides may also be produced by the copolymerization of aliphatic monomer precursors for polyamides as documented by T. K. Kang, Y. Kim, W. J. Cho, and C. S. Ha in 36(20) POLYMER ENGINEERING AND SCIENCE, p. 2525 (1996). Suitable aliphatic, all-amorphous polyamides are available from Kolon Company, Korea.

Nylons having hardness values of less than 90 (Shore D) and preferably less than 85 may be used. In other embodiments, softer TPVs may be formed using nylons having hardness values of less than 80 and preferably less than 75.

Polyamide elastomers, including polyether block amides (e.g., Pebax™ available from Arkema) may also be used in the subject compositions in place of, or in addition to, the polyamide of the plastic phase, particularly where it is desirable to reduce the hardness of the resulting TPV. Polyamide elastomers are described in THERMOPLASTIC ELASTOMERS, Ch. 9 (G. Holden, H. R. Kricheldorf, and R. P. Quirk, eds., Hansen/Gardner Publications, Cincinnati, Ohio (2004)). Suitable polyamide elastomers may have hardnesses ranging from 25 to 70 Shore D.

The adhesive performance of the TPV with respect polar, and specifically polyamide substrates may be improved by reducing the melt viscosity of the TPV so as to improve the flow of the TPV over the substrate and so as to facilitate the flow of the TPV into the various undulations and imperfections on the substrate surface. TPV melt viscosity is dependent on the melt viscosity of the plastic phase and is therefore controlled by the melt viscosity of the polyolefin and, where present, the polyamide. To that end, it may be desirable in one embodiment to select a functionalized polyolefins having a relatively high melt flow rate. Preferably the melt flow rate of the functionalized polyolefin as defined under ASTM D1238 (230° C., 2.16 kg) is between approximately 600 and 100, with a melt flow rate of between 500 and 200 g/10 min preferred, and a melt flow rate of between 475 and 350 g/10 min more preferred, and a melt flow rate of between 475 and 375 g/10 min being most preferred. Exemplary functionalized polyolefins in this range include Polybond 3000 which is a 1.1 wt % maleated isotactic polypropylene having a melt flow rate of approximately 400 g/10 min, and Fusabond P MD 353 D which is a maleated propylene\ethylene random copolymer chain having a high maleic anhydride content (greater than 1.5 wt %), and a melt flow rate of approximately 450 g/10 min.

Maleated product from branched polypropylenes such as PF814 from Basell Polyolefins or Daploy™ WB130HMS from Borealis may be useful in the present invention as these materials would exhibit the high flow characteristics of the parent polyolefins under injection overmolding conditions.

Higher molecular weight, and therefore lower melt flow rate, functionalized polyolefins may be suitable for the practice of this invention if the polyolefins are highly functionalized, as the adverse effect on adhesion due to poor TPV melt wetting characteristics is counteracted by the increased functional group content in the polyolefin. These TPVs, then, would have improved mechanical properties, in addition to exhibiting good adhesion in overmolding. High molecular weight polypropylene containing a high maleic anhydride graft level is described in U.S. Pat. No. 5,955,547 to Roberts et al., and may be used in place of part or all of the conventional functionalized polyolefins described herein.

To reduce melt viscosity of the plastic phase of the TPV, it may also be desirable to select a polyamide having a relatively low melt viscosity. In one embodiment the polyamide may have a relative viscosity as measured in 90% formic acid, in accordance with the process described in the DuPont Elvamide® Product and Properties Guide (2004), of between 20 to 200, with a relative viscosity of 20 to 100 being preferred, and 20 to 50 being most preferred. Typical commercially available injection molding grades of nylon are preferred and are within the preferred range of relative viscosities.

To further reduce the viscosity of the polyamide, a polyamide plasticizer may be added to the thermoplastic elastomer composition. Polyamide plasticizers may be added in amounts from 0.1 to 25 wt % with respect to the polyamide and preferably from 5 to 25% and most preferably 10 to 15% with respect to the polyamide. Exemplary nylon plasticizers include N-(n-butyl)benzenesulfonamide and 2-ethylhexyl-4-hydroxy benzoate.

Improvement in the adhesive properties of the TPVs of the present invention, with respect to polar, and specifically, polyamide substrates may also be achieved by selecting, as the functionalized plastic, functionalized copolymers of alpha-olefins and acrylate monomers. The exemplary alpha-olefin may be ethylene. Exemplary acrylate monomers may include butyl acrylate, 2-ethylhexyl acrylate, methyl acrylate, ethyl acrylate, acrylonitrile, and methyl methacrylate monomers. The functionalized plastic may also include functionalized copolymers of ethylene and vinyl acetate. These plastics, that are more polar than the maleated polyolefins previously discussed, would exhibit increased adhesion to the nylon substrate surface because of the additional polar interaction between the pendant ester groups of the plastic and nylon. One example of such a plastic is a maleic anhydride functionalized copolymer of ethylene and butylacrylate, which is sold under the tradename Fusabond AEB560D, available from DuPont. This material has a melt index of 5.6 g/10 min (190° C., 2.16 kg). These plastics may be used in place of part or all of the plastic phase of the TPV composition.

Maleated plastic hardness can be used as one of the tools to control end product hardness. In this connection, maleated ethylene/acrylate copolymers, maleated propylene/ethylene copolymers, and maleated poly(1-butene), would reduce product hardness when used in place of maleated polypropylene for TPV preparation.

The adhesive property of the TPV of the present invention may be improved by the selection of low crystallinity polyamides, as it is expected that the greater the amorphous phase content of the nylon in the TPV, the better the adhesion of the TPV to the nylon substrate. Rates of crystallization may also be lower, the lower the nylon crystallinity, thus allowing adhesive property improvement due to increased wetting time of the substrate surface by the molten TPV. A standard nylon 6 grade such as Ultramid B3 may have 35% to 40% crystallized structure. Polyamides having a percent crystalline structure of less than 30% and in another embodiment less than 25% and in still another embodiment less than 20% and in yet another embodiment of 15% may be selected. An exemplary polyamide having a percent crystalline form of 15% is Elvamide 8066. This polyamide also has a low relative viscosity of 21 to 29. The rise of softer, lower crystallinity nylon is another tool that can be used to reduce TPV hardness.

Classes of high molecular weight, but yet high flow polyamide and polyamide blends (i.e., having low melt viscosities) are known in the art and may be selected for use in the thermoplastic vulcanizate compositions of the present invention in place of conventional polyamides. These polyamides may have number average molecular weight in the range of 25,000 to 80,000 but a relative melt viscosity of less than 50, and preferably from 20 to 50.

### Polyesters

Polyesters suitable for use in the present invention are any of the linear or branched saturated polyesters known to those of skill in the art. Generally, the polyesters comprise linear saturated polyesters derived from C₁-C₁₀ alkyleneglycols such as ethylene glycol, propylene glycol and 1,4-butanediol, including cycloaliphatic glycols, such as 1,4-cyclohexane-dimethanol and mixtures of any of these glycols with one or more aromatic dicarboxylic acids. Preferably, the polyesters comprise poly(C₁-C₆ alkylene terephthalates) prepared by known techniques, such as the transesterification of esters of terephthalic acid alone or mixtures of esters of terephthalic acid and isophthalic acid, with the glycol or mixture of glycols and subsequent polymerization, by heating the glycols with the free acids or with halide derivatives thereof, and similar processes. These methods are described in U.S. Pat. Nos. 2,465,319 and 3,047,539, incorporated by reference herein. In addition, blends of one or more of these polyesters or copolyesters may be employed. A suitable poly(1,4-butylene terephthalate) resin is commercially available from General Electric Company under the tradename VALOX® 315. Poly(ethylene terephthalate) resins are also well known and commercially available.

The thermoplastic vulcanizates of the present invention may further include at least one polyamide which, in combination with the functionalized polyolefin, may form the plastic phase of the TPV. The polyamide may be grafted onto the functionalized, non-elastic polyolefin.

One or more common additives may added to the TPV to affect the characteristics or processability of the TPV.

The functional group in the functionalized polyolefin may be an anhydride, and is preferably maleic anhydride (“anhydride functionalized polyolefin”). The thermoplastic elastomer may have a hardness of between 35 and 75.

The thermoplastic elastomer may have a peel adhesion to a polyamide substrate at room temperature of greater than 15 pounds per linear inch. This peel adhesion may be achieved by over molding the polyamide substrate without heating the substrate.

As noted above, the TPV comprises an elastomer. The amount of the elastomer in the TPV as a percentage by weight of the total amount of the elastomer plus plastic, including polyamide, in the TPV may be from 20 to 80 wt %, and in another embodiment, from 30 to 70 wt %, and in yet another embodiment, from 40 to 60 wt %, and in a preferred embodiment, from 35 to 65 wt %.

### Functionalized Polyolefins

The term “functionalized polyolefin” refers to a polyolefin containing reactive functional groups. Suitable polyolefins include isotactic polypropylene (“iPP”), homopolymers of ethylene, including high density polyethylene, low density polyethylene, very low density polyethylene, ethylene/propylene copolymer, ethylene/1-butene copolymer, ethylene/1-hexene copolymer, ethylene/1-octene copolymer (collectively, the polyethylene homopolymers and copolymers are referred to as “polyethylene” unless otherwise stated); isotactic poly(1-butene) and copolymers of 1-butene with ethylene, propylene, 1-hexene, or 1-octene (collectively, the isotactic poly(1-butene) homopolymers and copolymers are referred to as “isotactic poly(1-butene” unless otherwise stated); and syndiotactic polypropylene and copolymers of syndiotactic propylene with ethylene, 1-butene, 1-hexene, or 1-octene (collectively, the syndiotactic propylene homopolymers and copolymers are referred to as “syndiotactic propylene” unless otherwise stated), ands blends of the aforementioned. Functionalized poly(4-methyl-1-pentene) and copolymers thereof are also useful in the present invention.

Functional groups (also referred to as reactive groups) may include carboxylic acids and their derivatives, including acid anhydrides, acid chlorides, isocyanates, oxazolines, amines, hydroxides, and epoxides. For purposes of the present invention, the preferred functional group is an anhydride and most preferably maleic anhydride.

These reactive groups can be on the polyolefin polymer backbone, such as in copolymers of styrene and maleic anhydride available from NOVA Chemicals, under the trademark Dylark™ or the reactive groups may be grafted onto the main polyolefin backbone. Examples include polypropylene grafted with maleic anhydride available from Eastman Chemicals as Epolene E-43™, or polypropylene or polyethylene grafted with acrylic acid or maleic anhydride available from Chemtura Corp under the trademark POLYBOND, or Exxelor™ from ExxonMobil, or Fusabond™ which includes maleated isotactic polypropylene and maleated propylene/ethylene random copolymers from E. I. du Pont de Nemours and Company.

Many of these functionalized polyolefins are marketed directly as grafted copolymers or as blends. Examples of blends include Plexar™ grades from—Equistar Chemical Co., Bynel™ grades from DuPont, Modic™ and Novatec™ from Mitsubishi, Admer™ from Mitsui, and Lupolen™ from Basell B.V.

Isotactic polypropylene modified with an anhydride, and preferably maleic anhydride is an exemplary functionalized non-elastic polyolefin. This product may be referred to as maleated isotactic polypropylene or iPP-g-MAH. The modified isotactic polypropylene may be grafted with between 0.5 to 2.0 wt % of maleic anhydride. The weight percent of maleic anhydride may exceed 2.0%. In another embodiment, the weight percent of maleic anhydride may be from 0.75% to 2.0% and in another embodiment, from 1.0% to 2.0% and in still another embodiment, from 1.0% to 1.5% and in still another embodiment, from 0.5% to 1.0%. iPP-g-MAH having 1.0% maleic anhydride is sold by Chemtura Corporation under the trademark POLYBOND 3000.

Though iPP-g-MAH is preferred, other functionalized polyolefins referred to herein, including other maleated polyolefins, may be incorporated into the TPVs of the present invention. The synthesis of polyolefin graft copolymers, including those containing MAH grafts, is reviewed by T. Hagiwara et al., 44 JOURNAL OF POLYMER SCIENCE PART A: POLYMER CHEMISTRY, pp. 3406-3409 (2006); and G. Moad in PROGRESS IN POLYMER SCIENCE, Ch. 24, pp. 81-142 (1999). Functionalized polyolefins having levels of functionality greater than 2%, as described in U.S. Publication No. 2006-0084764A1 to Hana et al., which teaches MAH functionalized polyolefins having a MAH content greater than 2 wt %, may be used in the present invention.

In one embodiment of the invention, the polyolefin of the TPV comprises greater than 80 wt % of the total polyolefin of one or a blend of more than one functionalized, and preferably, anhydride functionalized polyolefin. In another embodiment, the polyolefin comprises greater than 90% and in yet another embodiment, greater than 95% and in still another embodiment, greater than 97% of one or a blend of more than one functionalized polyolefin. In a preferred embodiment, the polyolefin consists essentially of one or a blend of more than one functionalized polyolefin.

It is contemplated that the polyolefin will comprise greater than 80%, and in other embodiments, 90%, 95% and 97% respectively, by weight of functionalized polyolefin, preferably anhydride functionalized polyolefin. This restriction is intended to define an upper limit on the amount of unmodified polyolefin (i.e., polyolefin chains having no functional group graft along the polymer chain) which may be added to the TPV composition, preferably, no more than 20 wt %, and in other respective embodiments, 10%, 5%, and 3%, of the polyolefin added to the TPV will be unmodified polyolefin. It will be recognized that commercially available functionalized, polyolefins having greater than 0.5 wt % of maleic anhydride, including the POLYBOND 3000 referenced herein, may have an amount of unmodified polyolefin chains, though it will be noted that when maleic anhydride level in the polyolefin is greater than 0.5 wt % it is generally believed that there is essentially no unmodified polyolefin chains. It is preferable that the selected commercially available functionalized polyolefin not have a known concentration of unmodified polyolefin chains that is greater than 20%, and preferably 10%. Moreover, it will be recognized that processing the TPV, which may involve significant shearing forces and heat, may break apart some portion of the functionalized polyolefin strands to form unmodified polyolefin chains. It is believed that the combination of these two effects will not introduce more than 20 wt % of unmodified polyolefin chains into the total polyolefin portion of the TPV; nevertheless, when referring to the composition of the polyolefin or the TPV, the lower limit of 20%, and in other embodiments, 10%, 5% and 3% of unmodified polyolefin refers to the sum of all sources unmodified polyolefin.

In the most preferred embodiment, substantially the entire plastic phase comprises functionalized polyolefin; namely polypropylene, grafted with between 0.5 to 2.0 wt % of maleic anhydride. The term “substantially the entire polyolefin” means that preferably no unmodified polyolefin, other than that which may be incidental to the functionalized polyolefin, is intentionally incorporated into the TPV.

The plastic phase of the TPV may comprise a polyamide in addition to the polyolefin. An amount of polyamide may be added to the TPV composition to improve the affinity of the TPV with respect to polyamide substrates. Where present the amount of the polyamide (weight percent with respect to the total plastic plus polyamide in the plastic phase) may be from 20 to 80 wt % and preferably from 30 to 70 wt % and still more preferably from 40 to 60 wt %.

### Methods for Making Thermoplastic Vulcanizates

Any process for making TPVs may be employed. TPVs are prepared using conventional blending techniques known to those skilled in the art. In one or more embodiments, the individual materials and components, such as the one or more rubber components, thermoplastic resin components, additive oils, curatives, other additives, etc., may be blended by melt-mixing in any order in a mixer heated to above the melting temperature of the thermoplastic resin component. Curatives may be added before during or after blending, i.e., in separate curing steps or as part of the initial blending of rubber and thermoplastic components.

The one or more components, thermoplastic resin components, and curing agents can be added to a heated mixer as individual feed streams, as a tumbled blend, or as a masterbatch. The one or more thermoplastic resin components can be added before cure or divided in any proportions between before cure and after cure. The additive oil, e.g., process oil, can be added during mastication before cure, after cure, or divided in any proportions between before cure and after cure.

Preferably, the one or more curing agents are incorporated into the melt within a target range of melt temperature over a specified period of time (<120 seconds). The one or more curing agents can be added using any suitable technique, such as by injection as a solution in a compatible process oil, as a neat solid, as a neat melt, or as a masterbatch, for example.

One or more fillers or other additives can be introduced to the melt either before, during or after the cure. The additives, fillers or other compounds, which may interfere with the curing agents, should be added after curing reaches the desired level. Preferably, those additives are added to the melt as a slurry or paste in a compatible rubber process oil. Powder blends or masterbatches of these components can be prepared in a wax or polymer carrier to facilitate metering and mixing. Following the cure and sufficient mixing of the melt, the melt blend can be processed to form an elastomeric structure using any one or more of the following techniques: milling, chopping, extrusion, pelletizing, injection molding, or any other desirable technique.

Additional details for making TPVs and conventional TPV compositions are described in U.S. Pat. Nos. 4,594,390; 4,311,628; 5,672,660; 5,843,577; 6,300,418; Japanese Patent Application No. JP 2005 336359; and an ANTEC 2006 paper of May 8, 2006, which are each incorporated herein by reference.

### Thermoplastic Vulcanizate Properties

Thermoplastic vulcanizate compositions can be processed and recycled like thermoplastic materials (ASTM D1566). The term “dynamic vulcanization” is herein intended to include a vulcanization process in which a vulcanizable elastomer is vulcanized under conditions of high shear in the presence of a thermoplastic polyolefin resin. As a result, the vulcanizable elastomer is simultaneously crosslinked and dispersed as fine particles within the resin.

Thermoplastic elastomer (“TPE”) and TPV compositions are elastic in that they are capable of recovering from deformations. One measure elastic behavior is that a material will retract to less than 1.5 times its original length within one minute, after being stretched at room temperature to twice its original length and held for one minute before release (ASTM D1566). Another measure is found in ASTM D412, for the determination of tensile set. The materials are also characterized by high elastic recovery, which refers to the proportion of recovery after deformation and may be quantified as percent recovery after compression. A perfectly elastic material has a recovery of 100% while a perfectly plastic material has no elastic recovery. Yet another measure is found in ASTM D395, for the determination of compression set.

### End-Use Applications

TPVs are molded in to articles by conventional molding techniques known to those skilled in the art. For example, molded articles can be formed via injection molding or coextrusoin techniques.

Typical molded articles include vehicle sealing systems, coatings, e.g., low friction coatins, thermoplastic veneers, thermoplastic overmoldings, films, tapes, noise attenuating devices, automotive interior surfacing, automotive and industrial belts and hoses, packaging (in decorative and protective applications), construction materials, decorative building materials and consumer goods such as handbags, backpacks, clothing, hand or power tools, drawer and cabinet liners, picture frames, and hunting decoys.

Vehicle sealing systems include glass run channels, door seals, belt line seals, body side moldings, sunroof moldings and windshield moldings. Vehicles contemplated include, but are not limited to, passenger automobiles, trucks of all sizes, farm vehicles, trains and the like.

The above description is intended to be illustrative of the invention, but should not be considered limiting. Persons skilled in the art will recognize that various modifications may be made without departing from the spirit and scope of the invention. Accordingly, the invention will be deemed to include all such modifications that fall within the appended claims and their equivalents.

Further, with respect to all ranges described herein, any bottom range value may be combined with any upper range value.

### Automotive Sealant Structures

A typical automotive seal structure includes a first piece, i.e., first structure, adhered to a second piece, i.e., second structure. At least one portion of the first piece is adhered to a portion of the second piece such that the first piece and the second piece are adhered to one another. For example, the first and second piece are adhered end to end, or “butt-welded” as is known in the art.

The first piece includes a first elastomeric component that includes an at least partially crosslinked rubber component and a first olefinic thermoplastic component that includes a propylene copolymer that has (i) 60 wt % or more units derived from propylene; (ii) isotactically arranged propylene derived sequences; and (iii) a heat of fusion less than 45 J/g. In at least one embodiment the first olefinic thermoplastic component includes a silicon containing additive, e.g., siloxane masterbatch.

The first elastomeric component may also include a second olefinic thermoplastic component. Use of such propylene copolymers imparts a higher elastic performance to the composition and therefore has a self healing effect for scratches such that TPV surfaces retrieve an original shape after action of an indenter, without generating a definitive surface fracture.

In at least one embodiment, the at least partially crosslinked rubber component includes thermoset EPR. In one or more of the embodiments, the at least partially crosslinked rubber component includes thermoset EPDM. In one or more of the embodiments, the at least partially crosslinked rubber component is present in the amount of from about 5 wt % to about 85 wt % based on the total weight of the first piece. In one or more of the embodiments identified above or elsewhere herein, the at least partially crosslinked rubber component is present in the amount of less than 70 wt % or less than 50 wt % based on the total weight of the first piece.

In at least one embodiment, the first olefinic thermoplastic resin component is present in the amount of from about 15 wt % to about 95 wt % based on the total weight of the first piece. In one or more of the embodiments, the first olefinic thermoplastic resin component is present in the amount of more than 30 wt % or more than 50 wt % based on the total weight of the first piece.

In at least one embodiment, the propylene copolymer is present in the amount of from about 1 wt % to about 50 wt % based on the total weight of the first piece. In one or more of the embodiments, the propylene copolymer is present in the amount of from about 5 wt % to about 15 wt % based on the total weight of the first piece. In one or more of the embodiments, the propylene copolymer is present in the amount of from about 10 wt % to about 40 wt % based on the total weight of the first piece.

In at least one embodiment, the propylene copolymer is a propylene/ethylene copolymer having an ethylene content of greater than 8 wt % and up to about 30 wt % based on total weight of the propylene copolymer. In one or more embodiments identified above or elsewhere herein, the propylene copolymer is a propylene/ethylene copolymer having an ethylene content of from about 10 wt % to about 15 wt % based on total weight of the propylene copolymer.

In at least one embodiment, the first elastomeric component includes of from about 10 wt % to about 60 wt % of one or more additive oils, based on total weight of the first piece. More preferably, the first elastomeric component includes of from about 25 wt % to about 40 wt % of one or more additive oils, based on total weight of the first piece. In one or more embodiments, the first elastomeric component includes of from about 0.1 wt % to about 5 wt % of one or more curatives, based on total weight of the first piece. More preferably, the first elastomeric component includes of from about 0.2 wt % to about 1.5 wt % of one or more curatives, based on total weight of the first piece. In one or more embodiments, the first elastomeric component includes of from about 1 wt % to about 25 wt % of one or more fillers, based on total weight of the first piece. More preferably, the first elastomeric component includes of from about 2 wt % to about 15 wt % of one or more fillers, based on total weight of the first piece.

In at least one embodiment, the first piece has a Shore A Hardness of 75 or less. In one or more embodiments, the first piece has a Shore A Hardness of 70 or less, or 65 or less, or 60 or less. In one or more embodiments, the first piece has a Shore A Hardness of from 50 to 70.

In at least one embodiment, the adhesion between the first piece and the second piece is about 2.5 MPa or more. In one or more of the embodiments, the adhesion between the first piece and the second piece is about 3.0 MPa or more. In one or more embodiments, the adhesion between the first piece and the second piece is about 3.5 MPa or more. In one or more embodiments, the adhesion between the first piece and the second piece is about 3.6 MPa or more. In one or more embodiments, the adhesion between the first piece and the second piece is about 4.0 MPa or more.

In one embodiment, the automotive sealing system is composed of: (a) a first component; (b) a second component composed of a grafted propylene-based elastomer; and (c) a third component comprising a polar material. The grafted propylene-based elastomer is composed of propylene-derived monomer units and from about 0.1 to about 10 wt % of graft comonomer units, based on the weight of the grafted propylene-based elastomer. The grafted propylene-based elastomer has a heat of fusion of less than 75 J/g and a Tₘ of less than 105° C. The third component is at least partially adhered to the second component and the second component is at least partially adhered to the first component. This embodiment improves scratch resistance for softer TPV, e.g., 60-70 Shore A Hardness, which may be sensitive to scratches due to weaker mechanical resistance to an indenter action.

In another embodiment, an automotive sealant structure is composed of: (a) a sealant foot, and (b) a sealant lip. The sealant foot is composed of: (a) a first olefinic thermoplastic component; (b) a second olefinic thermoplastic component; and (c) carbon black. The first olefinic thermoplastic component is composed of a propylene copolymer having: (i) 60 wt % or more units derived from propylene; (ii) isotactically arranged propylene derived sequences; and (iii) a heat of fusion less than 45 J/g. The sealant lip is composed of an elastomeric component that includes an at least partially crosslinked rubber, and a third olefinic thermoplastic component. The sealant lip is at least partially adhered to the sealant foot. In at least one embodiment, the elastomer component is EPDM rubber and the second olefinic thermoplastic component is propylene homopolymer or a random copolymer derived from propylene. The sealant foot has a Shore A Hardness of 75 or less, a density of less than 0.90 g/cc, and the adhesion between the sealant foot and the sealant lip is about 3.0 MPa or more. In at least one embodiment, the sealant foot has a compression set of less than 90% at 125° C. and less than 75% at 70° C.

This embodiment is especially useful for glass run seal applications wherein the seal lip is a TPV/TPO performance material and a slipcoating material to provide low coefficient of friction and freeze resistance. The sealant foot provides structural support to the sealing lips at low cost. Preferably, sealant foots are composed of compositions having minimum Compression set of less than 90% at 125° C. and less than 85% at 70° C. both at 22 hrs.

Using a blend of olefinic material, e.g., Vistamaxx 6102 propylene-based elastomer, polypropylene, i.e., homo or random copolymer, and black concentrate instead of conventional fully compounded TPV/TPO reduces costs due to reduction of specific gravity from, for example, 0.97 g/cc for TPV to less than 0.90 g/cc, e.g., 0.87 g/cc for the new olefinic blends described herein. The new blends permit an increase of running production extrusion time due to the lack of filler. By comparison, conventional TPV materials may die plug extrusion lines and thereby cause lost production time due to shut down and re-start, which results in wasted resources, time, and money.

An exemplary cost savings area is in the “foot” area of automotive seals since the foot is the largest portion of the profile, e.g., approx 80% of the profile. The “foot” provides structural support to performance areas, such as sealing lips.

Provided is a co-extrusion of high performance material, e.g., Santoprene TPV, used on a sealing lip areas of glass run seals and a lower performance, low cost material blend used on the “foot” area of the glass run seals where the non-performance material can be used. The “foot” area function is to support the sealing lips providing the structure.

In one or more embodiments, the foot includes a blend of Vistamaxx propylene-based elastomer, polypropylene, and carbon black. The compression set at 22 hr@70° C. at 25% compression should be less than 85% max with a density of 0.80 g/cc to 0.9 g/cc, hardness of 75 Shore A Hardness to 84 Shore A Hardness. The foot may also optionally include fillers. An exemplary weatherseal is shown in FIG. 2.

### Nylon Bonding

Conventional techniques for bonding elastomers or TPVs to nylon surfaces require high nylon surface temperatures, e.g., 150° C., in order to obtain good bond strength with a TPV. Conventional injection overmolding techniques exemplify use of high temperatures for bonding. However, in certain embodiments nylon bonding is improved at lower temperatures.

Further, some conventional TPVs use a polyamide, e.g., nylon 6, as a blend component to improve TPV adhesion to polyamide surfaces. However, TPV compositions having a polyamide component often exhibit reduced melt viscosity, reduced compression set, and a loss of tensile strength, e.g., 15-20% loss of tensile strength. For example, conventional TPVs having a tensile strength of about 871 psi (6005 kPa) may exhibit a reduction of tensile strength of almost 20%, to about 730 psi (5033 kPa), upon addition of a nylon compatibilizer.

In at least one embodiment, low temperature bonding is accomplished by a thermoplastic elastomer composed of (a) a rubber, (b) plastic phase composed of a polyamide and greater than 80 wt % of a functionalized polyolefin. Preferably the functionalized polyolefin is selected from the group consisting of polypropylene, polyethylene, poly(1-butene), poly(4-methyl-1-pentene), and blends thereof. Preferably, the rubber is selected from the group consisting of conjugated diene rubber, a styrenic block copolymer rubber, unsaturated styrenic triblock copolymer rubber, hydrogenated styrenic triblock copolymer rubber, and blends thereof.

In a preferred embodiment, the elastomer comprises a styrenic triblock rubber, the plastic phase comprises: (i) functionalized isotactic polypropylene; and (ii) a polyamide. In a more preferred embodiment, the elastomer exhibits one or more of the following: (a) an ultimate tensile strength greater than about 700 psi (4826 kPa); (b) an ultimate elongation greater than about 300%; (c) a compression set less than about 35; and (d) a viscosity of less than 55 (1200 s−1, 240° C.).

Described below are further embodiments of the inventions provided herein:

A. A thermoplastic elastomer comprising:

(a) a thermoplastic phase comprising a propylene-based copolymer having:
a heat of fusion of less than 75 J/g, and
a Tₘ of less than 105° C.;

(b) from about 0.1 to about 10.0 wt % of a siloxane masterbatch; and

(c) a rubber phase.

B. The thermoplastic elastomer of embodiment A, wherein the siloxane masterbatch comprise siloxane and a carrier resin comprising polyethylene, polypropylene, a poly alpha olefin copolymer, or combinations thereof.
C. The thermoplastic elastomer of embodiment A or B, wherein the thermoplastic elastomer has a hardness of less than 70, or less than 65, or less than 60, or less than 55.
D. The thermoplastic elastomer of any of embodiments A-C, wherein the thermoplastic elastomer has a scratch resistance of 3 or greater as measured by ISO 4586-2.
E. The thermoplastic elastomer of any of embodiments A-D, wherein the thermoplastic elastomer includes from about 3.5 to about 4.5 wt % of siloxane masterbatch.
F. An automotive sealing system comprising:

(a) a first sealing component;

(b) a second sealing component comprising the thermoplastic elastomer of any of embodiments A-E; and

(c) a third sealing component comprising a polar material;

wherein the third component is at least partially adhered to the second component and the second component is at least partially adhered to the first component.

G. An sealant structure comprising:

(a) a sealant foot comprising:
(i) a first olefinic thermoplastic component comprising a propylene copolymer having:
   60 wt % or more units derived from propylene,
   isotactically arranged propylene derived sequences, and
   a heat of fusion less than 45 J/g,

(b) a sealant lip comprising:
(i) an elastomeric component that includes an at least partially crosslinked rubber; and
(ii) a third olefinic thermoplastic component,
   wherein the sealant foot is at least partially adhered to the sealant lip.
   H. The sealant structure of embodiment G, wherein the sealant foot further comprises a second olefinic thermoplastic component.
   I. The sealant structure of embodiment G or H, wherein the sealant foot further comprises carbon black.
   J. The sealant structure of any of embodiments G-I, wherein the elastomer component is EPDM rubber.
   K. The sealant structure of any of embodiments G-J, wherein the second olefinic thermoplastic component is propylene homopolymer or a random copolymer derived from propylene.
   L. The sealant structure of any of embodiments G-K, wherein the sealant foot has a Shore A Hardness of 75 or less.
   M. The sealant structure of any of embodiments G-L, wherein the sealant foot has a density of less than 0.90 g/cc.
   N. The sealant structure of any of embodiments G-M, wherein the adhesion between the sealant foot and the sealant lip is about 3.0 MPa or more, or about 3.5 MPa or more.
   O. The sealant structure of any of embodiments G-N, wherein the sealant foot has a compression set of less than 90% at 125° C.
   P. The sealant structure of any of embodiments G-0, wherein the sealant foot has a compression set of less than 75% at 70° C.
   Q. The sealant structure of any of embodiments G-M, wherein the sealant structure is an automotive seal system.
   R. A thermoplastic elastomer comprising:

(a) thermoplastic phase comprising:
(i) greater than 80 wt % of a functionalized polyolefin selected from the group consisting of polypropylene, polyethylene, poly alpha olefin copolymers, and blends thereof;
(ii) a poly alpha olefin polymer comprising monomers derived from butene; and
(iii) a polyamide; and

(b) a rubber phase.

S. The thermoplastic elastomer of embodiment R, wherein the functionalized polyolefin is isotactic polypropylene grafted malaic anhydride.
T. The thermoplastic elastomer of embodiment R or S, wherein the poly alpha olefin polymer is a copolymer comprising butene comonomer.
U. The thermoplastic elastomer of embodiment R or S, wherein the poly alpha olefin polymer is isotactic poly(1-butene).
V. The thermoplastic elastomer of any of embodiments R-U, wherein the rubber phase comprises a rubber selected from the group consisting of conjugated diene rubber, a styrenic block copolymer rubber, unsaturated styrenic triblock copolymer rubber, hydrogenated styrenic triblock copolymer rubber, and blends thereof
W. The thermoplastic elastomer of any of embodiments R-V, wherein the elastomer comprises a styrenic triblock rubber.
X. The thermoplastic elastomer of any of embodiments R-W, wherein the thermoplastic elastomer has an ultimate tensile strength greater about 700 psi (4826 kPa).
Y. The thermoplastic elastomer of any of embodiments R-X, wherein the thermoplastic elastomer has an ultimate elongation greater than about 300%.
Z. The thermoplastic elastomer of any of embodiments R-Y, wherein the thermoplastic elastomer has a compression set less than about 35.
AA. The thermoplastic elastomer of any of embodiments R-Z, wherein the thermoplastic elastomer has a viscosity of less than 55 (1200 s−1, 240° C.).
BB. The thermoplastic elastomer of any of embodiments R-Z, wherein the rubber phase comprises EP(VNB)DM, EP(ENB)DM, or combinations thereof.
CC. The sealant structure of any of embodiments G-Q, wherein the rubber phase comprises EP(VNB)DM, EP(ENB)DM, or combinations thereof.
DD. The thermoplastic elastomer of any of embodiments A-E, wherein the rubber phase comprises EP(VNB)DM, EP(ENB)DM, or combinations thereof.
EE. A container comprising:

a propylene polymer

from about 0.1 to about 15 wt %, based on the weight of the container, of a propylene alpha olefin copolymer,

wherein the container has:

a haze less than 2.0%, and

a clarity of greater than 97.0.

FF. The container of embodiment EE, wherein the propylene alpha olefin copolymer has:

60 wt % or more units derived from propylene,

isotactically arranged propylene derived sequences, and

a heat of fusion less than 45 J/g.

GG. The container of embodiment EE or FF, wherein the container comprises from about 0.1 to about 7.0 wt % propylene alpha olefin copolymer.
HH. The container of embodiment EE or FF, wherein the container comprises from about 0.1 to about 5.0 wt % propylene alpha olefin copolymer.
II. The container of embodiment EE or FF, wherein the container comprises from about 0.1 to about 2.5 wt % propylene alpha olefin copolymer.
JJ. The container of any of embodiments EE-II, wherein the container is a cup having drop impact failure height at 35° F. (2° C.) greater than about 50 inches when measured according to the steps comprising:

(i) refrigerating the cup for 24 hours; and

(ii) dropping the cup using a Brewston Stair-Step drop test.

KK. The container of embodiment JJ, wherein the container has a drop impact failure height at 35° F. (2° C.) greater than about 80 inches.

### EXAMPLES

### Example 1

The following tests compare scratch resistance of a conventional Santoprene TPV, i.e., 121-62M100 (“M100”), with TPVs of similar hardness, which are commercially available from ExxonMobil as 121-62M200 (“M200”). The M200 TPV includes 10 wt % of a propylene-ethylene copolymer that is commercially available as Vistamaxx propylene based elastomers from ExxonMobil Chemical Corp. of Houston, Tex. The M100 and M200 formulations were combined with a siloxane masterbatch (“Si M.B.”), which is commercially available from Dow Chemical Corp. of Midland Mich. as MB50-321.

The formulations are provided in Table 1:

TABLE 1
Formulations

| | | | Silicone | Scratch Test |
|---|---|---|---|---|
| Ingredients | M100 | M200 | Masterbatch | ISO 4586-2 |
| M100 + Si M.B. | 96 | — | 4 | 2+ |
| M200 + Si M.B. | — | 96 | 4 | 3 |
| M100 | | | | 1 |
| M200 | | | | 1+ |

As shown in Table 1, M200 exhibited better scratch resistance compared to M100 despite a lower modulus, i.e., lower physical resistance to indentation. When modified with silicone masterbatch, M200 offers better scratch resistance.

As shown in Table 2, Vistamaxx propylene-based elastomers impart toughness, i.e., a high elasticity, to the composition.

TABLE 2
Physical Properties

| | | | | M100 + | M200 + |
|---|---|---|---|---|---|
| | Unit | M100 | M200 | Si M.B. | Si M.B. |
| Hardness | Shore A | 69 | 62 | 70 | 64 |
| Gloss @ 60° | ° | 12 | 39 | 15 | 37 |
| Break strain | % | 283.5 | 445.2 | 330.5 | 484.1 |
| Break stress | MPa | 3.95 | 5.06 | 4.69 | 5.54 |
| Toughness break | MPa | 1.1 | 2.3 | 1.6 | 2.7 |
| Mod 50 | MPa | 2.48 | 1.95 | 2.72 | 2.05 |

Using Vistamaxx propylene-based elastomers in TPV compositions, and Vistamaxx propylene-based elastomers combined siloxane masterbatches, provides better physical properties for use in visible application and in contact with exterior aggression. This solution is valid to other type of soft TPE like SEBS based material.

### Example 2

A triplex extrusion trial was performed to prove the manufacturability of the glass run seal using a blend of Vistamaxx 6102/5341 PP, Santoprene 121-73W175, and slipcoating 123-45S100. Table 3 shows physical properties of the blends:

TABLE 3

| | | | | | Tensile S | Aged T.S | | | | |
|---|---|---|---|---|---|---|---|---|---|---|
| | | | C. Set @25% | C. Set @25% | (psi) | (psi) | | Stress at | Tear | |
| | | | comp | comp | ASTM D | ASTM D | Elongation | 100% | S. at | |
| | Hardness | Density | 70° C.@22 hr | 125 C.@22 hr | 412 Room | 412 168 hr | (%) ASTM | M100 | room | Aged Tear at |
| Sample | Shore A | (g/cc) | ASTM D 395 | ASTM D 395 | Temp | @100 C. | D 412 | (psi) | temp | 168 hr@100° C. |
| 90% 6102 | 76 | 0.87 | 64 | 69 | 2803 | 1721 | 895 | 441 | 263 | 265 |
| 10% 5341 | | | | | (19326 kPa) | (11866 kPa) | | | | |
| | | | | | | (38.6%) | | | | |
| 85% 6102 | 82 | 0.87 | 66 | 82 | 2749 | 1756 | 912 | 558 | 328 | 315 (4%) |
| 15% 5341 | | | | | (18954 kPa) | (12107 kPa) | | | | |
| | | | | | | (36.1%) | | | | |
| 80% 6102 | 84 | 0.87 | 70 | 88 | 2306 | 1966 | 863 | 646 | 355 | 351 (1.1%) |
| 20% 5341 | | | | | (15899 kPa) | (13555 kPa) | | | | |
| | | | | | | (14.7%) | | | | |
| SBS ** | 70 | | 97 | | | | | | | |
| Low | | | | | | | | | | |
| performance | | | | | | | | | | |
| SEBS ** | | 1.13 | 51 | | | | | | | |
| Medium | | | | | | | | | | |
| performance | | | | | | | | | | |
| Santoprene | 78 | 0.97 | 33 | 42 | 1280 | −9.0% | 510 | 460 | 140 | −2% |
| 121-73W175 | | | | | (8825 kPa) | | | | | |

** Note:
the data was presented by Meztzeler Automotive Profile System, Jun. 12, 2008

Compression set data was retested as shown in Table 4:

TABLE 4
Physical Properties, Unaged

| | | |
|---|---|---|
| TPE-0016 | Compression set, 22 hrs, @70° C., % set | 75.6 |
| TPE-0016 | Compression set, 22 hrs, @125° C., % set | 83.9 |

### Example 3

New nylon bondable compositions were compared to conventional TPVs. Referring to Tables 5 and 6, conventional TPVs were prepared by melt blended a nylon compatibilizer with a thermoplastic vulcanizate composed of an isotactic polypropylene grafted malaic anhydride (iPP-g-MAH) and EP(VNB)DM. The conventional TPVs were prepared with either Polybond 3000 (iPP-g—1.2 wt % MAH, m.p. 160-170° C., 1000 MFR). See TAHA 3003, Table 5 and TAHA 3009, Table 6. The conventional TPVs were melt blended with Ultramid B3 a nylon 6 that is commercially available from BASF, an injection molding grade.

New nylon-bondable compositions were prepared by combining the same EP(VNB)DM as in the conventional TPV with a thermoplastic phase composed of iPP-g-MAH and isotactic poly 1-butene (iPB). The thermoplastic phase was a blend of Polybond 3000 and an isotactic 1-butene/ethylene copolymer, PB 8640M (m.p. 117° C., 3.6 MFR). See TAHA 3006, Table 5 and TAHA 3011, Table 6.

In spite of the increased amount of polyolefin in the TPV plastic phase, the nylon-bondable TPVs exhibited excellent adhesion to cold insert nylon in injection overmolding. Replacing part of the iPP-g-MAH (m.p. 160-170° C.) with a lower melting (m.p. 117° C.) with non-functional poly(1-butene) was expected to reduce tensile strength and increase the 100° C. compression set of the nylon-bondable TPV. However, surprisingly, the nylon-bondable TPVs exhibited increased tensile strength and reduced compression set.

The nylon bondable TPVs exhibited increased tensile strength and elongation, and reduced compression set and melt viscosity compared to the conventional TPVs. Referring to Table 5, for example, compare the properties of TAHA 3024 with those of TAHA 3021. Comparing the reduced oil formulation in Table 6 with those of Table 5, nylon bondable TPVs prepared with slightly harder base TPVs yielded product physical properties and processability improvements. See, e.g., nylon bondable TPVs containing PB 8640M in Table 6.

All nylon-bondable TPVs exhibited tab tear when tested for peel strength after injection overmolding (525° F. (274° C.) melt temperature)) on to nylon 6 “T” bars.

TABLE 5
TPV Formulation & Properties

| | BASE (Comparative) | | NYLON BONDABLE | |
|---|---|---|---|---|
| TAHA | 3003 | 3006 | 3021 | 3024 |
| VX1696 | 200 | 200 | — | — |
| Ice cap K Clay | 30.0 | 30.0 | — | — |
| ZnO | 2.00 | 2.00 | — | — |
| PB 8640M | — | 25.0 | — | — |
| Polybond 3000 | 45.0 | 25.0 | — | — |
| Indopol H300 | 25.0 | 25.0 | — | — |
| (Upstream Polyisobutylene oil) | | | | |
| DC 2-5084 | 3.00 | 3.00 | — | — |
| Pt (0.22 wt % PC085 in | 3.00 | 3.00 | — | — |
| Chevron 6001R) | | | | |
| Indopol H300 | 25.0 | 25.0 | — | — |
| (Downsteam | | | | |
| Polyisobutylene oil) | | | | |
| Ultramid B3 (Nylon 6) | — | — | 40.0 | 40.0 |
| TAHA 3003 | — | — | 333 | |
| TAHA 3006 | — | — | — | 338 |
| Hardness (Shore A) | 62 | 61 | 65 | 63 |
| UTS (psi) | 815 (5619 kPa) | 816 (5626 kPa) | 700 (4826 kPa) | 763 (5261 kPa) |
| UE (%) | 326 | 385 | 269 | 363 |
| Comp. Set 22 hrs @ 100° C., % | 34 | 26 | 37 | 29 |
| Tension Set % | 7 | 9 | 8 | 16 |
| LCR (1200 s⁻¹, 240° C.) | — | — | 64 | 46 |
| Extruded Strand | — | — | Slightly | Smooth |
| Appearance | | | Rough | |

TABLE 6
TPV Formulation & Properties

| | BASE | | NYLON BONDABLE | |
|---|---|---|---|---|
| TAHA | 3009 | 3011 | 3018 | 3020 |
| VX1696 | 200 | 200 | — | — |
| Ice cap K Clay | 30.0 | 30.0 | — | — |
| ZnO | 2.00 | 2.00 | — | — |
| PB8640M | — | 25.0 | — | — |
| Polybond 3000 | 45.0 | 25.0 | — | — |
| Indopol H300 | 25.0 | 25.0 | — | — |
| (Upstream | | | | |
| Polyisobutylene oil) | | | | |
| DC 2-5084 | 3.00 | 3.00 | — | — |
| Pt (0.22 wt % PC085 in | 3.00 | 3.00 | — | — |
| Chevron 6001R) | | | | |
| Indopol H1900 | 10.0 | 10.0 | — | — |
| (Downstream | | | | |
| Polyisobutylene oil) | | | | |
| Ultramid B3 (Nylon 6) | — | — | 40.0 | 40.0 |
| TAHA 3009 | — | — | 333 | |
| TAHA 3011 | — | — | — | 338 |
| Hardness (Shore A) | — | 64 | 69 | 69 |
| UTS (psi) | — | 890 (6136 kPa) | 779 (5371 kPa) | 865 (5964 kPa) |
| UE (%) | — | 391 | 318 | 383 |
| Comp. Set 22 hrs @ 100° C., % | — | 29 | 40 | 30 |
| Tension Set % | — | 13 | 10 | 13 |
| LCR (1200 s⁻¹, 240° C.) | — | — | 73 | 53 |
| Extruded Strand | — | — | Slightly | Smooth |
| Appearance | | | Rough | |

TABLE 7
Adhesion of Nylon Bondable TPV to Glass Filled Cold Insert Nylon

| | Ave. Peel Load | Max. Peel Load | |
|---|---|---|---|
| | (lbf)(SD)* | (lbf)(SD)* | Failure Type |
| TA HA 3018 | 21.7 | 28.3 (2.3) | Adhesive Peel |
| (Conventional) | | | (all) |
| TA HA 3020 | 20.4 (1.0) | 24.8 (1.0) | Adhesive Peel |
| (Inventive) | | | (all) |

Aged in Room Temp. DI Water (168 hrs)

| | | | |
|---|---|---|---|
| TA HA 3018 | 18.1 (2.0) | 24.4 (5.1) | Adhesive Peel |
| (Conventional) | | | (all) |
| TA HA 3020 | — | 37.6 (7.1) | Tab Tear |
| (Inventive) | | | |

*lbf is equivalent to approximately 2.2046 kgf; Standard Deviation

TABLE 8
Adhesion of Nylon Bondable TPV to Glass Filled Cold Insert Nylon

| | Ave. Peel Load | Max. Peel Load | |
|---|---|---|---|
| | (lbf)(SD)* | (lbf)(SD)* | Failure Type |
| TA HA 3021 | 18.3 (0.79) | 30.6 (11.2) | Adhesive Peel |
| (Conventional) | | | (all) |
| TA HA 3024 | 20.3 (2.8) | 23.7 (2.2) | Adhesive Peel (2) |
| (Inventive) | | | Tab Tear (1) |

Aged in Room Temp. DI Water (168 hrs)

| | | | |
|---|---|---|---|
| TA HA 3021 | 18.1 (2.0) | 29.9 (16.6) | Adhesive Peel |
| (Conventional) | | | (all) |
| TA HA 3024 | 19.0 (1.1) | 24.9 (4.7) | Adhesive Peel |
| (Inventive) | | | (all) |

*lbf is equivalent to approximately 2.2046 kgf; Standard Deviation

### Example 4

Propylene copolymers were found to improve low temperature drop impact properties of polypropylene thermoformed parts without compromising optical characteristics. Surprisingly, only low levels of propylene copolymer were needed improve physical properties of thermoformed parts.

High-clarity thermoformed polypropylene drink cups and thin walled containers were prepared with and without addition of Vistamaxx propylene-based specialty elastomers.

Cold cups (16 oz) were prepared by blending ExxonMobil's PP6262 high clarity thermoforming polypropylene with ExxonMobil's Vistamaxx 6102 propylene-based elastomer, which has an MFR of 3, 16 wt % ethylene, and SE at 2.5% and 5.0% loadings. The blends were then extruded into sheets which were then thermoformed on an Illig thermoformer to produce cups for testing.

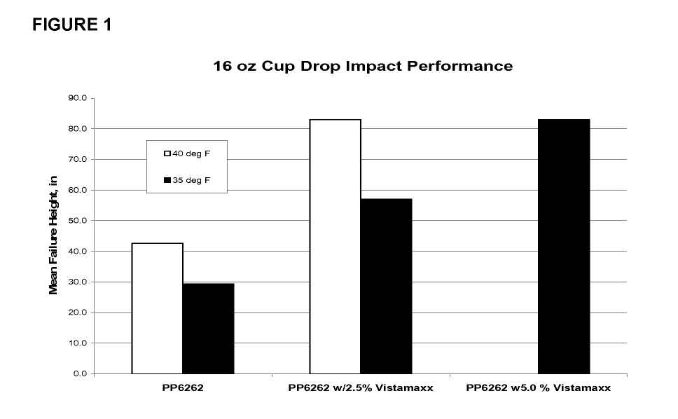

The cups were filled with water and sealed with a conventional snap-on lid. Filled cups were placed in a conventional refrigerator for 24 hours and then taken out and dropped within 30 seconds using a Brewston Stair-Step drop test. As shown in FIG. 1, a 2.5% loading of Vistamaxx almost doubled the drop impact failure height at both 35° F. (2° C.) and 40° F. (4° C.). FIG. 1 illustrates mean failure height results from a Brewson stair-step drop test.

Table 9 shows the optical properties of the cups measured at the center of the cup sidewall. As shown in Table 9, there is almost no loss in clarity at low level addition of Vistamaxx propylene-based elastomer.

TABLE 9
16 oz Cup Optical Properties

| | Haze, | Clarity, |
|---|---|---|
| | % | % |
| PP6262 | 1.4 | 97.9 |
| PP6262 and 2.5% | 1.8 | 97.5 |
| Vistamaxx propylene- | | |
| based elastomer | | |
| PP6262 and 5.0% | 1.9 | 97.1 |
| Vistamaxx propylene- | | |
| based elastomer | | |

Table 10 shows the stiffness of the cups. As shown in Table 10, the Vistamaxx propylene-based elastomer does not significantly lower stiffness, resulting in a cup with good grip properties and top load resistance.

TABLE 10
Cup Stiffness

| | Top | Side Wall |
|---|---|---|
| | Load, | Compression |
| | (N) | @10 mm, (N) |
| PP6262 | 290.0 | 4.8 |
| PP6262 w/2.5% Vistamaxx | 272.0 | 4.5 |
| PP6262 w/5.0% Vistamaxx | 266.0 | 4.2 |

What is claimed is:

1. A thermoplastic elastomer comprising:
(a) a thermoplastic phase comprising a propylene-based copolymer having:
a heat of fusion of less than 75 J/g, and
a Tₘ of less than 105° C.;
(b) from about 0.1 to about 10.0 weight percent of a siloxane masterbatch; and
(c) a rubber phase.

2. The thermoplastic elastomer of claim 1, wherein the siloxane masterbatch comprise siloxane and a carrier resin comprising polyethylene, polypropylene, or combinations thereof.

3. The thermoplastic elastomer of claim 1, wherein the thermoplastic elastomer has a hardness of less than 70 and a scratch resistance of 3 or greater, as measured by ISO 4586-2.

4. The thermoplastic elastomer of claim 1, wherein the thermoplastic elastomer includes from about 3.5 to about 4.5 wt % of siloxane masterbatch.

5. An automotive sealing system comprising:
(a) a first sealing component;
(b) a second sealing component comprising the thermoplastic elastomer of claim 1; and
(c) a third sealing component comprising a polar material,
wherein the third component is at least partially adhered to the second component and the second component is at least partially adhered to the first component.

6. An sealant structure comprising:
(a) a sealant foot comprising:
(i) a first olefinic thermoplastic component comprising a propylene copolymer having:
60 wt % or more units derived from propylene,
isotactically arranged propylene derived sequences, and
a heat of fusion less than 45 J/g;
(ii) a second olefinic thermoplastic component; and
(iii) carbon black, and
(b) a sealant lip comprising:
(i) an elastomeric component that includes an at least partially crosslinked rubber; and
(ii) a third olefinic thermoplastic component,
wherein the sealent foot is at least partially adhered to the sealant lip.

7. The sealant structure of claim 6, wherein:
(a) the sealant structure is an automotive seal system;
(b) the elastomer component is EPDM rubber;
(c) the second olefinic thermoplastic component is propylene homopolymer or a random copolymer derived from propylene; and
(d) the sealant foot has a Shore A Hardness of 75 or less.

8. The sealant structure of claim 6, wherein the sealant foot has a density of less than 0.90 g/cc.

9. The sealant structure of claim 6, wherein the adhesion between the sealant foot and the sealant lip is about 3.0 MPa or more.

10. The sealant structure of claim 6, wherein the sealant foot has a compression set of less than 90% at 125° C.

11. The sealant structure of claim 6, wherein the sealant foot has a compression set of less than 75% at 70° C.

12. A thermoplastic elastomer comprising:
(a) thermoplastic phase comprising:
(i) greater than 80 wt % of a functionalized polyolefin selected from the group consisting of polypropylene, polyethylene, poly alpha olefin copolymers, and blends thereof;
(ii) a poly alpha olefin polymer comprising monomers derived from butene; and
(iii) a polyamide, and
(b) a rubber phase.

13. The thermoplastic elastomer of claim 12, wherein the functionalized polyolefin is isotactic polypropylene grafted malaic anhydride.

14. The thermoplastic elastomer of claim 12, wherein the poly alpha olefin polymer is isotactic poly(1-butene).

15. The thermoplastic elastomer of claim 12, wherein the rubber phase comprises a rubber selected from the group consisting of conjugated diene rubber, a styrenic block copolymer rubber, unsaturated styrenic triblock copolymer rubber, hydrogenated styrenic triblock copolymer rubber, and blends thereof.

16. The thermoplastic elastomer of claim 12, wherein the rubber phase comprises a styrenic triblock rubber and the thermoplastic elastomer has:
an ultimate tensile strength greater about 700 psi (4826 kPa);
an ultimate elongation greater than about 300%;
a compression set less than about 35; and
a density a viscosity of less than 55 (1200 s−1, 240° C.).
